(19) United States
(12) Patent Application Publication
(10) Pub. No.: US 2024/0326092 A1
(43) Pub. Date: Oct. 3, 2024

(54) VIBRATION DEVICE

(71) Applicant: TDK Corporation, Tokyo (JP)

(72) Inventors: Shigeru KANEKO, Tokyo (JP); Chris T. BURKET, Lincolnshire, IL (US)

(21) Appl. No.: 18/621,849

(22) Filed: Mar. 29, 2024

Related U.S. Application Data
(60) Provisional application No. 63/493,423, filed on Mar. 31, 2023.

(51) Int. Cl. B06B 1/06; B06B 1/02

(52) U.S. Cl. CPC B06B 1/0648; B06B 1/0207

(57) ABSTRACT

Disclosed herein is a vibration device that includes: a coil; a drive circuit generating, based on induction electromotive force of the coil, a drive signal having a predetermined frequency; a piezoelectric element supplied with the drive signal; and a metal plate having a recess. The piezoelectric element is accommodated in the recess of the metal plate and stuck to a bottom surface of the recess through an adhesive.

### CROSS-REFERENCE TO RELATED APPLICATION

This application claims the benefit of Provisional Patent Application No. 63/493, 423, filed on Mar. 31, 2023, the entire disclosure of which is incorporated by reference herein.

### BACKGROUND

The present disclosure relates to a vibration device. JP 2014-132404 A discloses a non-contact type IC card having a capacitor for storing induction electromotive force generated in a coil and a vibration motor driven by electric power stored in the capacitor. US 2022/0138522 A discloses a metal smart card having a structure in which a chip module is accommodated in a through hole formed in a metal card body.

The IC card described in JP 2014-132404 A disadvantageously has a large number of components since it uses a capacitor for storing induction electromotive force. Further, when a piezoelectric element is used in place of a vibration motor, sufficient vibration cannot be produced.

### SUMMARY

A vibration device according to an aspect of the present disclosure includes: a coil; a drive circuit generating, based on induction electromotive force of the coil, a drive signal having a predetermined frequency; a piezoelectric element supplied with the drive signal; and a metal plate having a recess.

### BRIEF DESCRIPTION OF THE DRAWINGS

The above features and advantages of the present disclosure will be more apparent from the following description of certain embodiments taken in conjunction with the accompanying drawings, in which:

FIG. 1 is a schematic perspective view illustrating the outer appearance of a vibration device 1 according to an embodiment of the present disclosure;

FIG. 2 is a schematic exploded perspective view for explaining the structure of the vibration device 1;

FIG. 3 is a schematic plan view for explaining the structure of the metal plate 40;

FIG. 4 is a schematic cross-sectional view taken along the line A-A in FIG. 3;

FIG. 5A is a schematic cross-sectional view taken along the line A-A in FIG. 1;

FIG. 5B is a schematic cross-sectional view taken along the line B-B in FIG. 1;

FIG. 6 is a schematic plan view for explaining the positional relation between the recesses R1 to R3 and the DC generation circuit 120, drive circuit 130, and piezoelectric element 140;

FIG. 7 is a schematic plan view of conductor patterns formed on the surface 21 of the substrate 20;

FIG. 8 is a schematic perspective view of the IC module 50 as viewed from the back surface side thereof;

FIG. 9 is a circuit diagram of the DC generation circuit 120 and drive circuit 130;

FIG. 10 is a circuit diagram of the DC generation circuit 120 and drive circuit 130 according to a first modification;

FIG. 11 is a circuit diagram of the DC generation circuit 120 and drive circuit 130 according to a second modification; and

FIG. 12 is a schematic diagram showing a state in which the vibration device 1 and the card reader 6 communicate.

### DETAILED DESCRIPTION OF THE EMBODIMENTS

An object of the present disclosure to provide a vibration device having a reduced number of components and capable of producing sufficient vibration with a simple structure.

Some embodiments of the present disclosure will be explained below in detail with reference to the accompanying drawings.

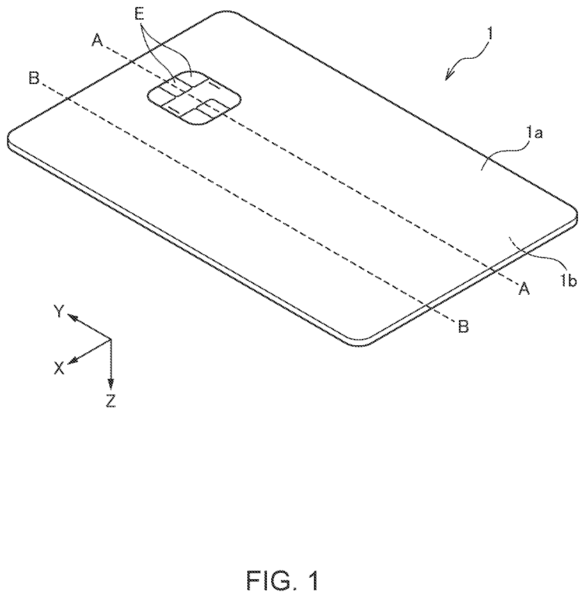

FIG. 1 is a schematic perspective view illustrating the outer appearance of a vibration device 1 according to an embodiment of the present disclosure.

As illustrated in FIG. 1, the vibration device 1 according to the present embodiment has a plate-like shape in which the Y-, X-, and Z-directions are defined as the longer length direction, the shorter length direction, and the thickness direction, respectively, and has an upper surface la and a back surface 1b which constitute the XY plane. A terminal electrode E of an IC module is exposed to the upper surface la of the vibration device 1.

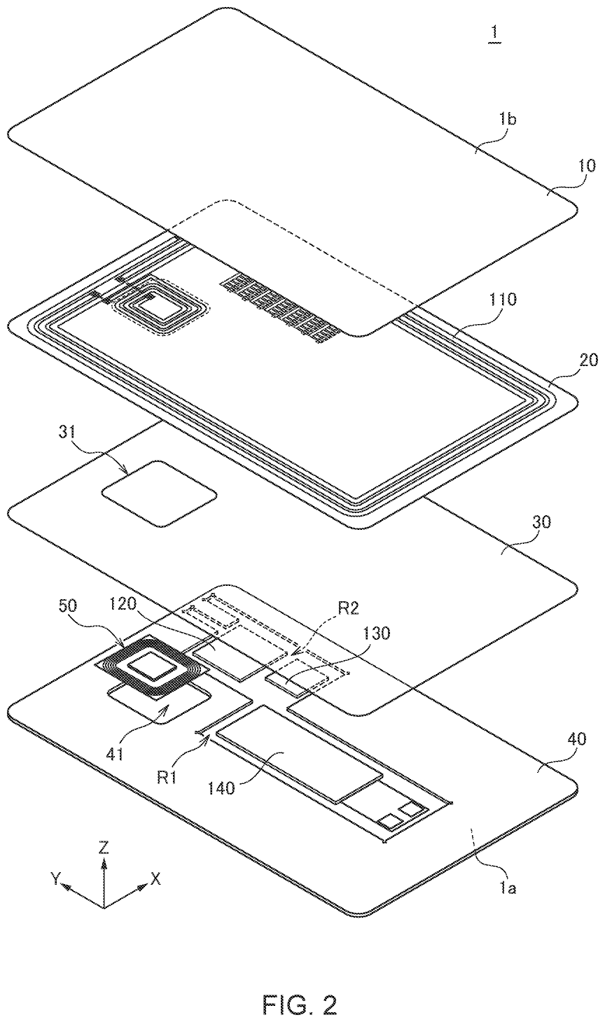

FIG. 2 is a schematic exploded perspective view for explaining the structure of the vibration device 1.

As illustrated in FIG. 2, the vibration device 1 has a structure in which a plastic plate 10, a substrate 20, a magnetic body 30, and a metal plate 40 are laminated in this order from the back surface 1b side to upper surface 1a side. The plastic plate 10 is made of a resin material not obstructing the passage of magnetic flux. The surface of the plastic plate 10 constitutes the back surface 1b of the vibration device 1. The metal plate 40 is made of a metal material such as stainless steel or titanium. The surface 20 of the metal plate 40 constitutes the upper surface la of the vibration device 1.

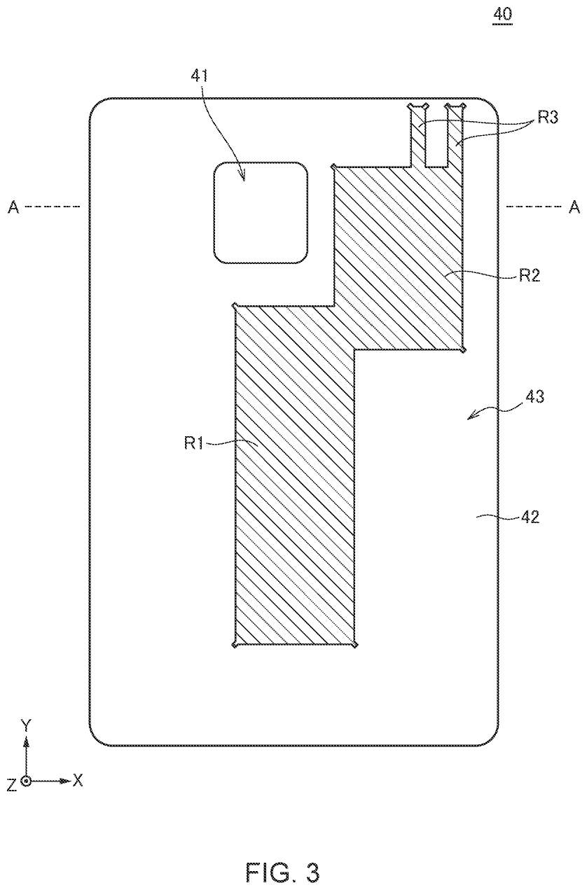

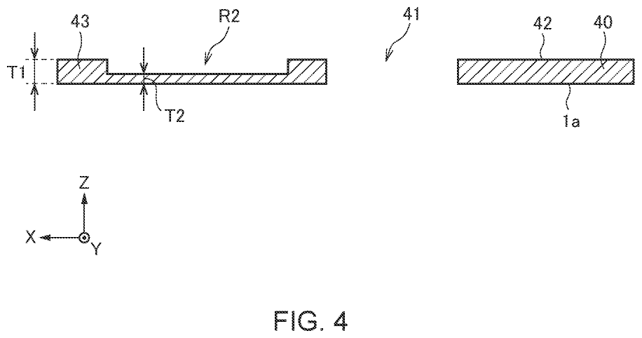

FIG. 3 is a schematic plan view for explaining the structure of the metal plate 40. FIG. 4 is a schematic cross-sectional view taken along the line A-A in FIG. 3.

As illustrated in FIGS. 3 and 4, the metal plate 40 has a through hole 41 formed therein. An IC module 50 illustrated in FIG. 2 is disposed inside the through hole 41. That is, the vibration device 1 according to the present embodiment is an IC card having a metal plate as its main body. The metal plate 40 has recesses R1 to R3 formed in a back surface 42 thereof. The thickness of the metal plate 40 in a main body part 43 where the recesses R1 to R3 are not formed is T1, and the thickness of a part of the metal plate 40 where the recesses R1 to R3 are formed is T2. The thickness T2 may be half or less of the thickness T1. In other words, the depth (T1-T2) of the recesses R1 to R3 may be equal to or larger than the thickness T2, allowing a piezoelectric element 140 with large driving force to be accommodated. The recess R1 is formed at substantially the center of the metal plate 40. The recess R2 is connected to the recess R1. The recess R3 is connected to the recess R2. The recesses R1 to R3 are formed so as not to reach the edges of the metal plate 40. Accordingly, the recesses R1 to R3 are not exposed to the XZ and XY side surfaces of the metal plate 40. That is, the edge part of the metal plate 40 has the thickness T1 over the entire periphery. This can maintain the aesthetic appearance of the IC card.

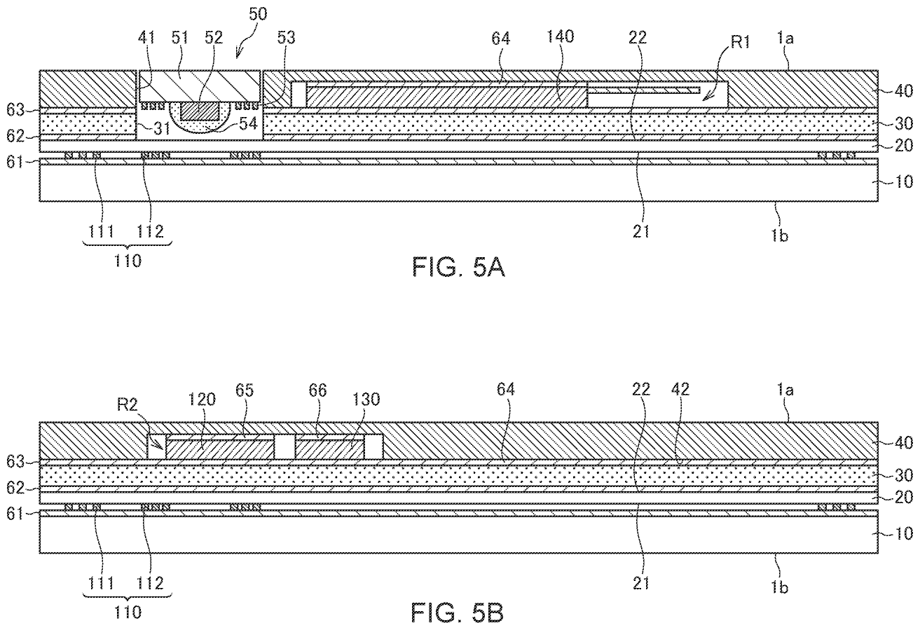

FIG. 5A is a schematic cross-sectional view taken along the line A-A in FIG. 1. FIG. 5B is a schematic cross-sectional view taken along the line B-B in FIG. 1.

As illustrated in FIG. 5A, the piezoelectric element 140 is accommodated in the recess R1 of the metal plate 40. The piezoelectric element 140 is stuck to the bottom surface of the recess R1 through an adhesive layer 64. A thermoplastic adhesive can be adopted for a material constituting the adhesive layer 64. The adhesive layer 64 is solidified at an ambient temperature to fix the metal plate 40 and piezoelectric element 140, allowing the displacement of the piezoelectric element 140 to be transmitted to the metal plate 40, which causes the metal plate 40 to vibrate. Further, as illustrated in FIG. 5B, a DC generation circuit 120 and a drive circuit 130 are accommodated in the recess R2 of the metal plate 40. The DC generation circuit 120 is stuck to the bottom surface of recess R2 through an adhesive layer 65. The drive circuit 130 is stuck to the bottom surface of the recess R2 through an adhesive layer 66.

The substrate 20 is a film made of an insulating resin material and has a coil formed of a coil pattern 110 on one surface 21 thereof. Examples of the insulating resin material constituting the film-like substrate 20 include PET (Polyethylene Terephthalate) and PI (Polyimide). By thus using a thin film-like member as the substrate 20 and forming the coil pattern 110 on the surface 21 of the substrate 20, the entire thickness can be reduced, which is suitable for application to an IC card. The one surface 21 of the substrate 20 faces the plastic plate 10, and the other surface 22 thereof faces the metal plate 40 through the magnetic body 30. The plastic plate 10 and substrate 20 are stuck to each other through an adhesive layer 61.

The surface 22 of the substrate 20 is covered with the magnetic body 30. The magnetic body 30 may be a sheet-like member or may be a member applied to the surface 22 of the substrate 20. When the magnetic body 30 is a sheet-like member, the magnetic body 30 and substrate 20 are stuck to each other through an adhesive layer 62 as illustrated in FIGS. 5A and 5B. When the magnetic body 30 is a member applied to the surface 22 of the substrate 20, the magnetic body 30 and substrate 20 directly contact each other without an adhesive layer therebetween.

The magnetic body 30 has a through hole 31 at a position overlapping the IC module 50. The through hole 41 formed in the metal plate 40 overlaps the through hole 31 formed in the magnetic body 30 in a plan view (as viewed in the z-direction). The magnetic body 30 and metal plate 40 are stuck to each other through an adhesive layer 63.

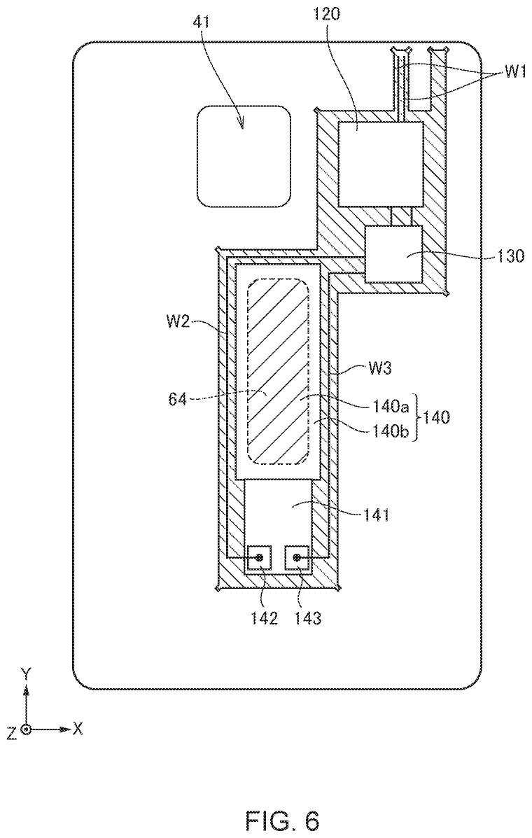

FIG. 6 is a schematic plan view for explaining the positional relation between the recesses R1 to R3 and the DC generation circuit 120, drive circuit 130, and piezoelectric element 140.

As illustrated in FIG. 6, the piezoelectric element 140 accommodated in the recess R1 includes a center area 140a and an outer peripheral area 140b which is positioned between the center area 140a and the outer peripheral edge of the piezoelectric element 140 so as to surround the center area 140a. The center area 140a is located at the center position of the metal plate 40 and is stuck to the bottom surface of the recess R1 through an adhesive layer 64. The piezoelectric element 140 has the largest displacement at the center area 140a. Thus, sticking this center area 140a to the metal plate 40 can transmit strong vibration to the metal plate 40.

The piezoelectric element 140 is connected to a flexible substrate 141. The flexible substrate 141 has thereon a pair of terminal electrodes 142 and 143. The piezoelectric element 140 is displaced by DC voltage applied to the terminal electrode 142 and 143. The terminal electrodes 142 and 143 are connected to the drive circuit 130 respectively by way of wires W2 and W3. As illustrated in FIG. 6, the flexible substrate 141 is positioned opposite the drive circuit 130 with respect to the piezoelectric element 140. Thus, part of the wires W2 and W3 each passes between the edge of the piezoelectric element 140 that extends in the Y-direction and the inner wall of the recess R1 that extends in the Y-direction and faces the above edge of the piezoelectric element 140. Disposing the flexible substrate 141 opposite the drive circuit 130 with respect to the piezoelectric element 140 makes it possible to locate the piezoelectric element 140 at the center of the metal plate 40.

The recess R2 accommodates therein the DC generation circuit 120 and drive circuit 130. The DC generation circuit 120 and coil pattern 110 are connected to each other through a pair of wires W1. The pair of wires W1 are accommodated in the recess R3.

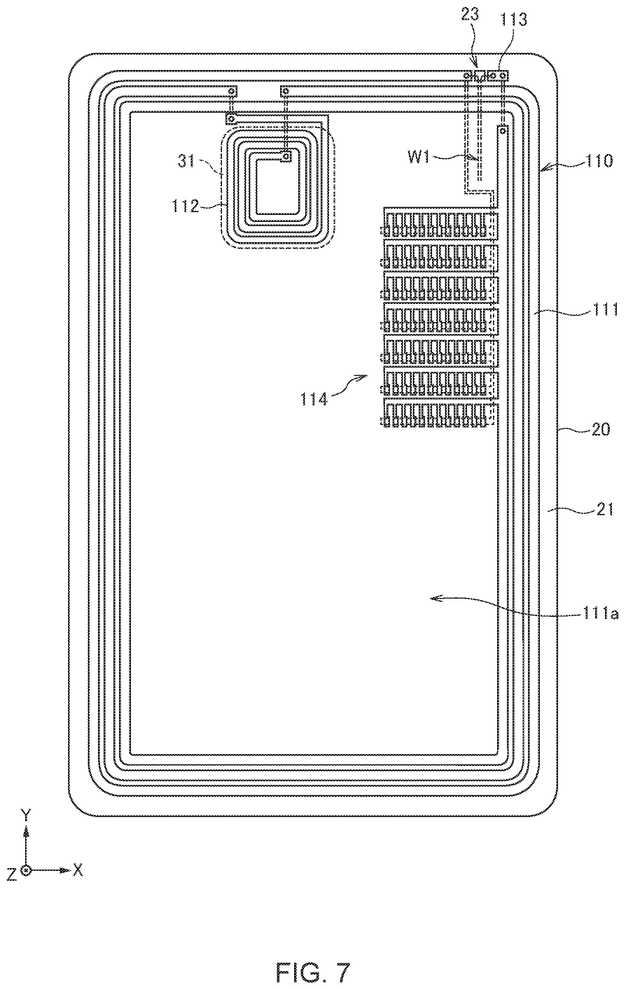

FIG. 7 is a schematic plan view of conductor patterns formed on the surface 21 of the substrate 20. In FIG. 7, the through hole 31 of the magnetic body 30 that is positioned on the surface 22 side of the substrate 20 is denoted by the dashed line.

As illustrated in FIG. 7, the substrate 20 has, on the surface 21 thereof, an antenna coil 111 and a coupling coil 112 which constitute the coil pattern 110, a connection pattern 113 connected to the inner peripheral end of the antenna coil 111, and one capacitive electrode of a capacitor pattern 114 connected to the innermost turn of the antenna coil 111. The other capacitive electrode of the capacitor pattern 114 is formed on the surface 22 of the substrate 20 as denoted by the dashed line. A conductor pattern connecting the inner peripheral end of the antenna coil 111 and the connection patter 113 and a conductor pattern connecting the outer peripheral end of the antenna coil 111 and the other capacitive electrode of the capacitor pattern 114 are also formed on the surface 22 of the substrate 20 as denoted by the dashed line. These patterns are made of a conductive material, and examples thereof include copper, aluminum, and an alloy thereof.

The antenna coil 111 has a pattern wound in about three turns along the outer edge of the substrate 20 so as to overlap the magnetic body 30 and forms a substantially rectangular shape whose longer and shorter length directions are the Y-direction and the X-direction, respectively. The coupling coil 112 is inserted into the second turn of the antenna coil 111 and is wound in about three turns along the inner edge of the through hole 31 of the magnetic body 30. As a result, the antenna coil 111 and coupling coil 112 are connected in series to each other. As denoted by the dashed line, conductor patterns connecting the inner and outer peripheral edges of the coupling coil 112 and the antenna coil 111 are formed on the surface 22 of the substrate 20. The antenna coil 111 and coupling coil 112 need not be connected in series to each other, but may be electromagnetically coupled to each other.

The inner and outer peripheral ends of the antenna coil 111 is connected to the DC generation circuit 120 by way of the pair of wires W1. One and the other of the pair of wires W1 are connected respectively to the outer peripheral end of the antenna coil 111 and connection pattern 113 through an opening 23 formed in the substrate 20. The antenna coil 111 has an elongated shape in the Y-direction as described above, and an opening area 111a thereof is also elongated in the Y-direction. The coupling coil 112, DC generation circuit 120, drive circuit 130, and piezoelectric element 140 are disposed so as to overlap the opening area 111a.

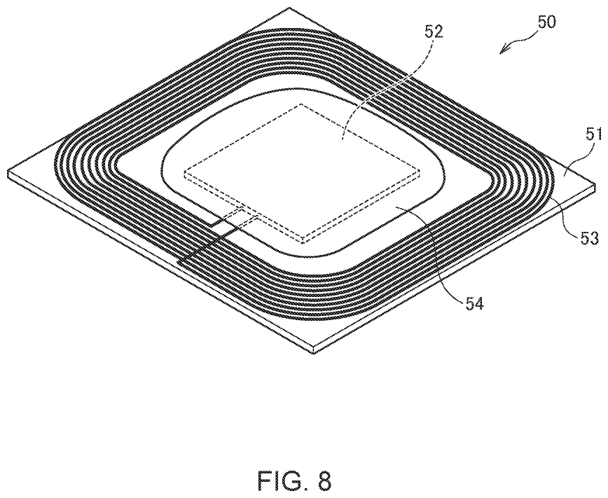

FIG. 8 is a schematic perspective view of the IC module 50 as viewed from the back surface side thereof.

As illustrated in FIG. 8, the IC module 50 includes a module substrate 51, an IC chip 52 mounted on or incorporated in the module substrate 51, and a coupling coil 53. The IC chip 52 is protected by being covered with a dome-shaped protective resin 54. The protective resin 54 is made of an insulating member. The terminal electrode E illustrated in FIG. 1 is provided on the back surface side of the module substrate 51. The IC module 50 thus configured is accommodated in the through hole 41 formed in the metal plate 40. In a state where the IC module 50 is accommodated in the through hole 41, the coupling coil 53 and the coupling coil 112 provided on the substrate 20 are electromagnetically coupled to each other. The coupling coil 112 is connected to the antenna coil 111 as described above, thus allowing the IC module 50 to communicate with external devices through the antenna coil 111. For example, by setting the resonance frequency of a resonance circuit constituted by the antenna coil 111 and a parasitic capacitance or another capacitive component connected to the antenna coil 111 to 13.56 MHz or band around 13.56 a frequency MHZ, NFC (Near Field Communication) is enabled. Although the antenna coil 111 and IC module 50 are coupled to each other through the coupling coils 112 and 53 in the present embodiment, they may be directly connected to each other.

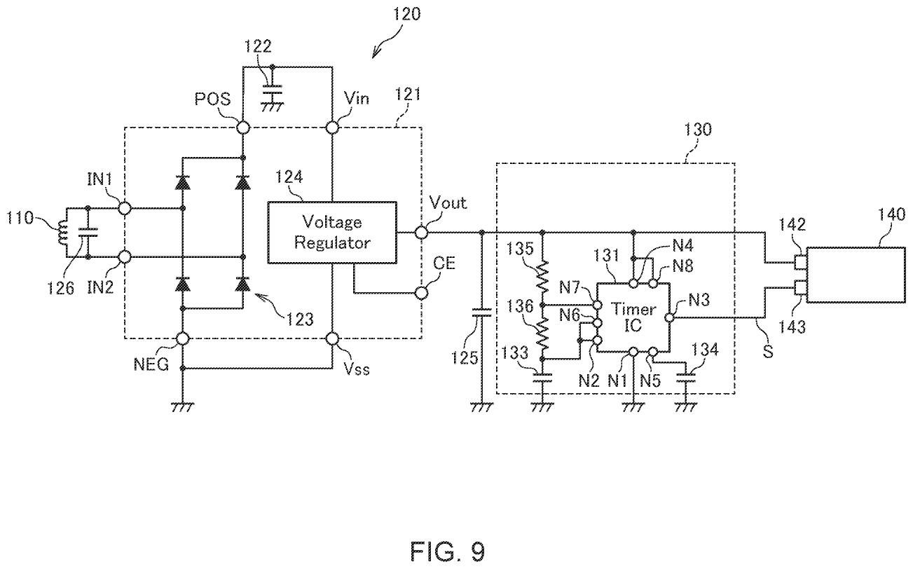

FIG. 9 is a circuit diagram of the DC generation circuit 120 and drive circuit 130.

The DC generation circuit 120 converts induction electromotive force generated in the coil pattern 110 into DC voltage and includes a power supply IC 121, an input capacitor 122, an output capacitor 125, and a frequency adjusting capacitor 126. The power supply IC 121 includes a diode bridge 123 and a voltage regulator 124. The diode bridge 123 is connected to a pair of AC input terminals IN1 and IN2 and a pair of DC output terminals POS and NEG. The AC input terminals IN1 and IN2 are connected respectively to the inner and outer peripheral ends of the antenna coil 111. The frequency adjusting capacitor 126 is connected between the AC input terminals IN1 and IN2. The capacitor 126 is formed of the capacitor pattern 114 illustrated in FIG. 7 and constitutes a resonance circuit together with the antenna coil 111. The DC output terminal POS is connected with the input capacitor 122. The DC output terminal NEG is grounded. The diode bridge 123 and input capacitor 122 constitute a rectifying circuit.

The voltage regulator 124 outputs a stabilized DC voltage from a DC output terminal Vout based on a DC voltage applied between a DC input terminal Vin and a ground terminal Vss. The output capacitor 125 is connected between the DC output terminal Vout and the ground. The DC input terminal Vin is connected to the DC output terminal POS, and the ground terminal Vss is grounded. The voltage regulator 124 may be activated when a voltage applied to an enable terminal CE exceeds a predetermined level. The enable terminal CE may be connected to the DC input terminal Vin. The capacitor 125 is connected between the DC output terminal Vout of the voltage regulator 124 and the ground; however, it has a capacitance of, for example, about 1 uF and thus does not function as a power supply. That is, the capacitor 125 does not have ability to store a DC voltage output from the DC output terminal Vout and drive the piezoelectric element 140 by discharge.

The drive circuit 130 includes a timer IC 131, capacitors 133 and 134, and resistors 135 and 136. The resistors 135, 136 and capacitor 133 are connected in series between the DC output terminal Vout of the voltage regulator 124 and the ground. The capacitors 133, 134 and resistors 135, 136 are elements that control the oscillation period and output waveform of the timer IC 131.

The timer IC 131 has a ground note N1, a trigger node N2, an output node N3, an inverted reset node N4, a voltage control node N5, a threshold node N6, a discharge node N7, and a power supply node N8. The inverted reset node N4 and power supply node N8 are connected to the DC output terminal Vout of the voltage regulator 124. Thus, when a DC voltage of a predetermined level is output from the DC output terminal Vout of the voltage regulator 124, the timer IC 131 starts its operation. When the DC output terminal Vout of the voltage regulator 124 does not reach a predetermined level, the inverted reset node N4 is brought to a low level (active level), with the result that the timer IC 131 is reset.

The discharge node N7 is connected to a connection point between the resistors 135 and 136. The trigger node N2 and the threshold node N6 are connected to a connection point between the resistor 136 and the capacitor 133. The voltage control node N5 is grounded through the capacitor 134. Thus, the frequency and waveform of a drive signal S output from the output node N3 can be adjusted by element constants of the capacitors 133, 134 and resistors 135, 136. The pair of terminal electrodes 142 and 143 provided for the piezoelectric element 140 are connected respectively to the DC output terminal Vout of the voltage regulator 124 and the output node N3 of the timer IC 131.

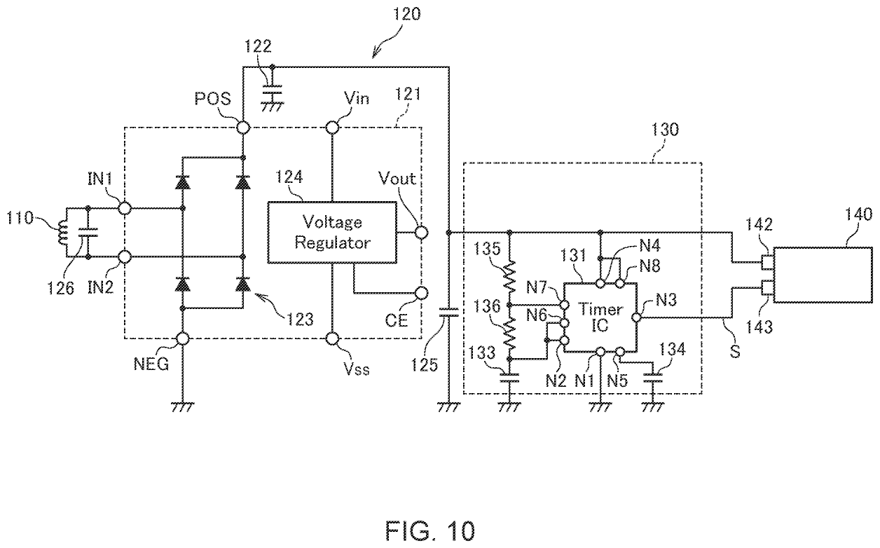

As illustrated in FIG. 10, the DC generation circuit 120 may have a circuit configuration that does not pass through the voltage regulator 124 included in the power supply IC 121. In this case, the DC output terminal POS of the power supply IC 121 is directly connected to the drive circuit 130. The voltage regulator 124 included in the power supply IC 121 may be disabled. The DC generation circuit 120 having such a circuit configuration can increase the voltage of the drive signal S.

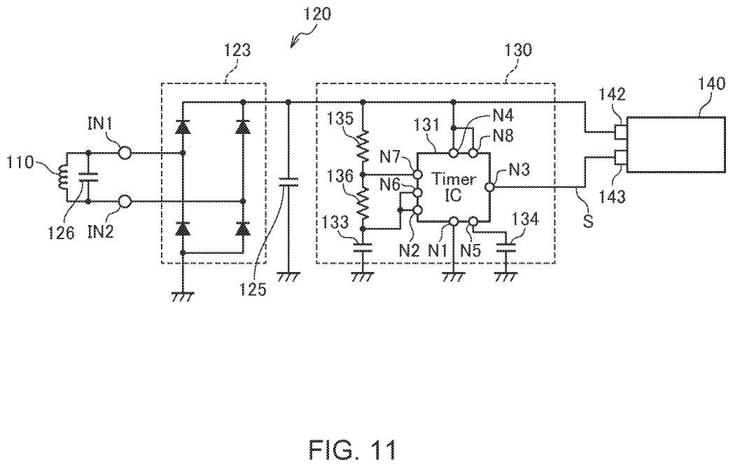

The DC generation circuit 120 may be constituted by the diode bridge 123 and output capacitor 125 instead of using the power supply IC 121, as illustrated in FIG. 11. This increases the voltage of the drive signal S as in the circuit configuration illustrated in FIG. 10. Further, a voltage loss is reduced by using a discrete Schottky barrier diode as a diode for the diode bridge 123, thus further increasing the voltage of the drive signal S.

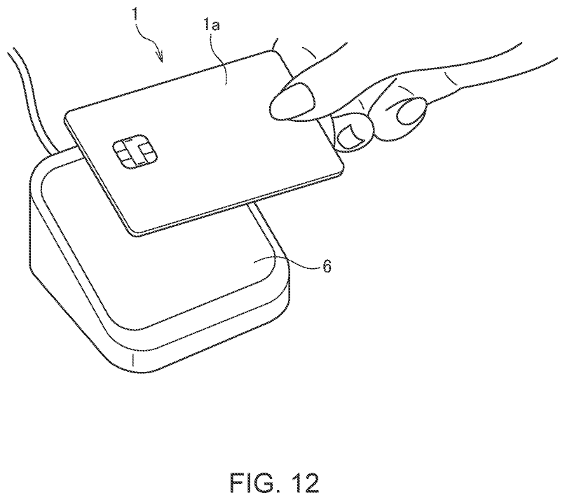

Thus, as illustrated in FIG. 12, when the back surface 1b of the vibration device 1 is made to face a card reader 6, communication can be performed between the card reader 6 and the IC chip 52. That is, the card reader 6 is coupled to the coupling coil 53 of the IC module 50 through the coil pattern 110 and can thereby communicate with the IC chip 52.

The induction electromotive force generated by the coil pattern 110 is converted into DC voltage by the DC generation circuit 120, and the drive signal S having a predetermined frequency is generated by the drive circuit 130. The generated drive signal S displaces the piezoelectric element 140. The piezoelectric element 140 is stuck to the metal plate 40 through the adhesive layer 64, thus transmitting the displacement of the piezoelectric element 140 to a user's hand holding the vibration device 1 and generating sound.

Such an operation starts when the DC generation circuit 120 is activated, that is, when a voltage of a predetermined level or more is generated in the coupling coil 112, allowing the user holding the vibration device 1 to feel the vibration and thus to recognize that communication between the vibration device 1 and the card reader 6 is being established.

Although the frequency of the drive signal S is not particularly limited to a specific one, stronger vibration can be generated when the frequency of the drive signal S is lower than audible frequencies. However, excessively low frequency of the drive signal S gives the user a sense of discomfort, so that the frequency of the drive signal S can be set to about 10 Hz to 20 Hz. When the frequency of the drive signal S is lower than audible frequencies, the user cannot hear sound waves directly produced by the displacement of the piezoelectric element 140, but sound waves produced by a harmonic component of the vibration of the metal plate 40 reaches the user's ears.

In the present embodiment, the metal plate 40 has the recesses R1 to R3, in which the DC generation circuit 120, drive circuit 130, piezoelectric element 140, and wires connecting them are accommodated. Thus, it is possible to ensure an adequate weight of the metal plate 40 while suppressing an increase in the entire thickness of the vibration device 1, whereby an IC card having moderate weightiness can be provided.

While some embodiment of the present disclosure has been described, the present disclosure is not limited to the above embodiment, and various modifications may be made within the scope of the present disclosure, and all such modifications are included in the present disclosure.

The technology according to the present disclosure includes the following configuration examples but not limited thereto.

A vibration device according to an aspect of the present disclosure includes: a coil; a drive circuit generating, based on induction electromotive force of the coil, a drive signal having a predetermined frequency; a piezoelectric element supplied with the drive signal; and a metal plate having a recess. The piezoelectric element is accommodated in the recess of the metal plate and stuck to the bottom surface of the recess through an adhesive. This allows the piezoelectric element to vibrate by induction electromotive force of the coil.

In the above vibration device, the depth of the recess may be half or more of the thickness of the metal plate. This allows a piezoelectric element with large driving force to be accommodated.

In the above vibration device, the piezoelectric element may include a center area and an outer peripheral area surrounding the center area, and the adhesive is provided at the center area. The piezoelectric element has the largest displacement at the center area, so that sticking this center area to the metal plate can transmit strong vibration to the metal plate.

In the above vibration device, the piezoelectric element may have an edge facing the inner wall of the recess, and the piezoelectric element and drive circuit may be connected to each other by way of wiring extending along the edge. This allows the piezoelectric element to be disposed at the center of the metal plate.

The above vibration device may further include a magnetic body overlapping the coil and recess of the metal plate. This increases inductance of the coil.

In the above vibration device, the recess may include first and second recesses connected to each other, the piezoelectric element may be accommodated in the first recess, and the driving circuit may be accommodated in the second recess. This facilitates connection between the piezoelectric element and the drive circuit.

The vibration device may further include a DC generation circuit that converts the induction electromotive force into DC voltage and supplies the DC voltage to the drive circuit, the recess may further include a third recess connected to the second recess, and a wiring connecting the DC generation circuit and the coil may be accommodated in the third recess. This facilitates connection between the DC generation circuit and the drive circuit and connection between the DC generation circuit and the coil.

In the above vibration device, the recess may not be connected to any of the edges of the metal plate. Thus, the recess is not exposed to the side surface of the metal plate, thus maintaining the aesthetic appearance of the IC card.

The above vibration device may further include a DC generation circuit that converts the induction electromotive force into DC voltage and supplies the DC voltage to the drive circuit, the coil may include an antenna coil and a coupling coil, the metal plate may have a through hole formed therein, the coupling coil may be electromagnetically coupled to an IC module disposed inside the through hole, and the DC generation circuit may generate the DC voltage based on the induction electromotive force generated between the inner and outer peripheral ends of the antenna coil. This allows a user to recognize electromagnetic coupling between the antenna coil and a card reader as an external device through vibration.

In the vibration device, the DC generation circuit may be activated when the voltage of the coupling coil exceeds a predetermined level. This allows a user to recognize communication establishment between an IC module included in the vibration device and a card reader as an external device through vibration.

The above vibration device may further include a magnetic body positioned between the coil and the metal plate, the magnetic body may have a through hole formed therein, and the through hole of the magnetic body may overlap the through hole of the metal plate. This allows the antenna coil and a card reader as an external device to be electromagnetically coupled to each other without being hindered by the metal plate and allows the coupling coil and IC module to be electromagnetically coupled to each other without being hindered by the magnetic body.

What is claimed is:

1. A vibration device comprising:
a coil;
a drive circuit based on induction generating, electromotive force of the coil, a drive signal having a predetermined frequency;
a piezoelectric element supplied with the drive signal; and
a metal plate having a recess,
wherein the piezoelectric element is accommodated in the recess of the metal plate and stuck to a bottom surface of the recess through an adhesive.

2. The vibration device as claimed in claim 1, wherein a depth of the recess is half or more of the thickness of the metal plate.

3. The vibration device as claimed in claim 1,
wherein the piezoelectric element includes a center area and an outer peripheral area surrounding the center area, and
wherein the adhesive is provided at the center area.

4. The vibration device as claimed in claim 1,
wherein the piezoelectric element has an edge facing an inner wall of the recess, and
wherein the piezoelectric element and the drive circuit are connected to each other by a wiring extending along the edge.

5. The vibration device as claimed in claim 1, further comprising a magnetic body overlapping the coil and the recess of the metal plate.

6. The vibration device as claimed in claim 1,
wherein the recess includes first and second recesses connected to each other,
wherein the piezoelectric element is accommodated in the first recess, and
wherein the driving circuit is accommodated in the second recess.

7. The vibration device as claimed in claim 6, further comprising a DC generation circuit converting the induction electromotive force into a DC voltage and supplying the DC voltage to the drive circuit,
wherein the recess further includes a third recess connected to the second recess, and
wherein a wiring connecting the DC generation circuit and the coil is accommodated in the third recess.

8. The vibration device as claimed in claim 1, wherein the recess is not connected to any of edges of the metal plate.

9. The vibration device as claimed in claim 1, further comprising a DC generation circuit that converts the induction electromotive force into DC voltage and supplies the DC voltage to the drive circuit,
wherein the coil includes an antenna coil and a coupling coil,
wherein the metal plate has a through hole formed therein,
wherein the coupling coil is electromagnetically coupled to an IC module disposed inside the through hole, and
wherein the DC generation circuit generates the DC voltage based on the induction electromotive force generated between an inner peripheral end and an outer peripheral end of the antenna coil.

10. The vibration device as claimed in claim 9, wherein the DC generation circuit is activated when a voltage of the coupling coil exceeds a predetermined level.

11. The vibration device as claimed in claim 9, further comprising a magnetic body positioned between the coil and the metal plate,
wherein the magnetic body has a through hole formed therein, and
wherein the through hole of the magnetic body overlaps the through hole of the metal plate.
